(19) United States
(12) Patent Application Publication
(10) Pub. No.: US 2017/0153104 A1
(43) Pub. Date: Jun. 1, 2017

(54) METHOD AND SYSTEM OF CHECKING SIGNAL OF ADJACENT LAYERS OF CIRCUIT BOARD

(71) Applicants: Inventec (Pudong) Technology Corporation, Shanghai (CN); INVENTEC CORPORATION, Taipei City (TW)

(72) Inventors: Yung-Chien CHENG, TAIPEI CITY (TW); Ming-Hui LIN, TAIPEI CITY (TW)

(21) Appl. No.: 15/077,897

(22) Filed: Mar. 22, 2016

(30) Foreign Application Priority Data
Nov. 30, 2015 (CN) 201510854563.1

(51) Int. Cl. G01B 7/02

(52) U.S. Cl. CPC G01B 7/02

(57) ABSTRACT

A method and a system of checking signals of adjacent layers of a circuit board are disclosed, where the method includes steps as follows. A check range of at least one check signal segment is required. It is determined whether the adjacent layers have an another signal segment in check range. When the adjacent layers have said another signal segment, the check signal segment and said another signal segment are merged to get a remaining area of the check range. The total area of the check range minus the remaining area leaves a segment area in the check range. The segment area divided by a default width determines a segment length. It is determined whether the segment length meets a predetermined length requirement.

### RELATED APPLICATIONS

This application claims priority to Chinese Application Serial Number 201510854563.1, filed on Nov. 30, 2015, which is herein incorporated by reference.

### BACKGROUND

Field of Invention

The present invention relates to circuit board checking technology. More particularly, the present invention relates to methods and systems of checking signals of adjacent layers of a circuit board.

Description of Related Art

A circuit board is an important electronic part that mechanically supports and electrically connects electronic components.

Circuit board layout design software currently provides a safety distance setting for different signals in the same layer. The safety distance setting mainly sets a minimum spacing between the different signals for a manufacturer to manufacture the circuit board, and avoid signal interference between the different signals in the same layer. However, signals of two adjacent layers may also cause signal interference; the current layout software cannot check and prevent this signal interference. Therefore, the engineers need visually checks, and some production problems occur due to human error, thereby increasing difficulties and the cost of production.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one embodiment, a method of checking signals of adjacent layers of a circuit board includes steps as follows. A check range of at least one check signal segment is required. It is determined whether the adjacent layers have an another signal segment in check range. When the adjacent layers have said another signal segment, the check signal segment and said another signal segment are merged to get a remaining area of the check range. The total area of the check range minus the remaining area leaves a segment area in the check range. A segment length is determined by the segment area divided by a default width. It is determined whether the segment length meets a predetermined length requirement.

In another embodiment, a system of checking signals of adjacent layers of a circuit board includes a storage device and a processor. The processor is electrically connected to the storage device. The storage device is configured to store checking signal data. The processor is programmed to execute steps of: based on the checking signal data, acquiring a check range of at least one check signal segment; determining whether the adjacent layers have another signal segment in check range; when the adjacent layers have said another signal segment, merging the check signal segment and said another signal segment to get a remaining area of the check range; leaving a segment area in the check range by a total area of the check range minus the remaining area; dividing the segment area in the check range by a default line width to determine a segment length; and determining whether the segment length in the check range meets a predetermined length requirement.

In view of the above, the present disclosure provides technology to achieve the purpose of automatic check. Thus, the check time can significantly shorten, and the omission check due to human error can be solved. The check results calculated by above system and/or above method are more accurate. For the precision design of the circuit board, electromagnetic interference between adjacent layers can be avoided. For the entire of the circuit board, reducing their design problems can also reduce the development costs.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a schematic diagram of signal interference of a circuit board according to one embodiment of the present disclosure;

FIG. 2 is a block diagram of a system of checking signals of adjacent layers of a circuit board according to one embodiment of the present disclosure;

FIGS. 3-8 are schematic diagrams of a method of checking signals of adjacent layers of a circuit board according to one embodiment of the present disclosure;

FIGS. 9 and 10 are a flow chart of a method of checking signals of adjacent layers of a circuit board according to one embodiment of the present disclosure; and

FIG. 11 is a flow chart of result display according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

As used in the description herein and throughout the claims that follow, the meaning of “a”, “an”, and “the” includes reference to the plural unless the context clearly dictates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

FIG. 1 is a schematic diagram of signal interference 130 of a circuit board 100 according to one embodiment of the present disclosure. As shown in FIG. 1, the circuit board 100 includes a plurality of layers 111-116. The signals 121 and 122 in differently adjacent layers. When the faster signal reaches a certain condition, even if the signals 121 and 122 in different layers, signal interference 130 occurs. The present disclosure focuses on this problem and develops automated systems and methods. Users manually set or software automatically defines and selects the check signal. The programs of the system automatically execute determination and calculation to acquire one or more signals that do not meet a design rule of adjacent layers.

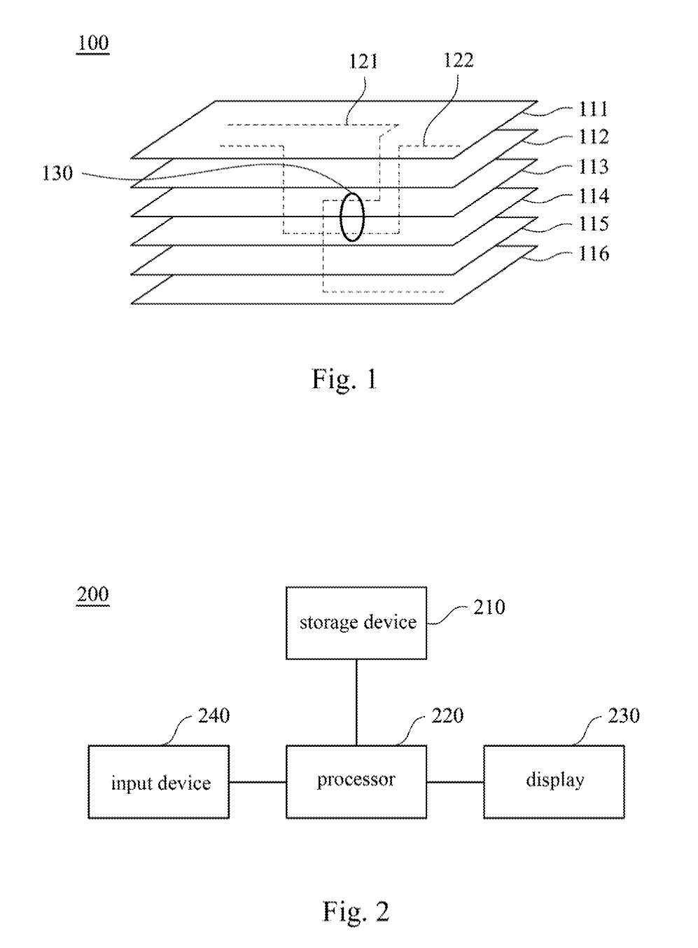

FIG. 2 is a block diagram of a system 200 of checking signals of adjacent layers of a circuit board according to one embodiment of the present disclosure. As shown in FIG. 2, the system 200 includes a storage device 210, a processor 220, a display 230 and an input device 240. In structure, the processor 220 is electrically connected to the processor 220, the display 230 and the input device 240.

In practice, the storage device 210 may be a hard disk, a flash memory or other memory device. The processor 220 may be a central processing unit, a micro-controller, or other processing circuitry. The display 230 may be a liquid crystal display or other display screen. The I/O device 240 may be a keyboard, mouse, a touch pad or the like. In one embodiment, the input device 240 and display 230 may be integrated into a touch screen.

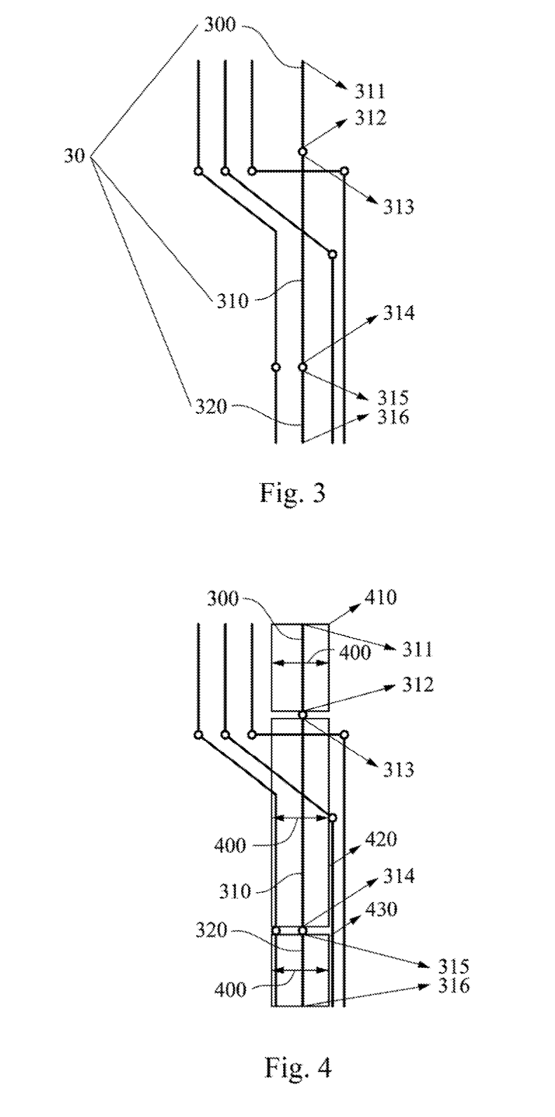

In one embodiment, the system 200 performs a method of checking signals of adjacent layers of the circuit board. The method implemented as software programs, stored in the storage device 210, is executed by the processor 220. The method performed by the system 200 will be illustrated with FIGS. 3-8 as below.

The storage device 210 store the checking signal data, and the checking signal data includes information on checking signals. The processor 220 is based on the checking signal data to inspect the checking signals one by one.

In one embodiment, the processor 220 is based on the checking signal data to acquire a check range of at least one check signal segment. Specifically, as shown in FIG. 3, a signal 30 includes, for example, check signal segment 300, 310 and 320. The processor 220 is based on the checking signal data to acquire the starting and ending coordinates 311-316 of the check signal segment 300, 310 and 320. Then, as shown in FIG. 4, the processor 220 uses the starting and ending coordinates 311-316 of the check signal segment 300, 310 and 320 with a predetermined distance 400, so as to establish the check range 410, 420 and 430 of the check signal segment 300, 310 and 320.

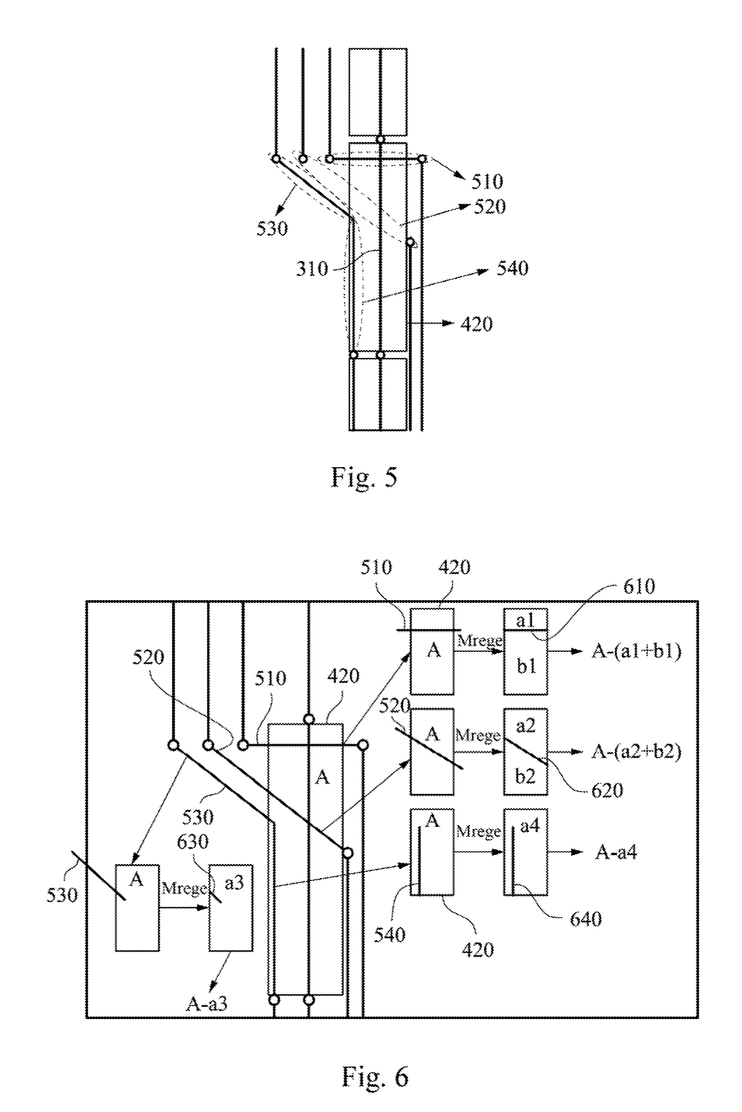

Then, in one embodiment, the processor 220 determines whether the adjacent layers have another signal segment in check range. Specifically, as shown in FIG. 5, the check range 420 is illustrated for example. The processor 220 determines that the check range 420 of the check signal segment 310 has another signal segments 510, 520, 530 and 540 of the adjacent layers.

Then, as shown in FIG. 6, the processor 220 merges the check range 420 and another signal segment 510 to acquire a remaining areas a1 and b1 of the check range 420; the total area A of the check range 420 minus the remaining areas a1 and b1 leaves a segment area 610 in the check range, and the segment area 610 is equal to A−(a1+b1). Similarly, the processor 220 merges the check range 420 and another signal segment 520 to acquire a remaining areas a2 and b2 of the check range 420; the total area A of the check range 420 minus the remaining areas a2 and b2 leaves a segment area 620 in the check range, and the segment area 620 is equal to A−(a2+b2). Similarly, the processor 220 merges the check range 420 and another signal segment 530 to acquire a remaining area a3 of the check range 420; the total area A of the check range 420 minus the remaining area a3 leaves a segment area 630 in the check range, and the segment area 630 is equal to A−a3. Similarly, the processor 220 merges the check range 420 and another signal segment 540 to acquire a remaining area a4 of the check range 420; the total area A of the check range 420 minus the remaining area a3 leaves a segment area 640 in the check range, and the segment area 640 is equal to A−a4. It should be noted that the adjacent layers have a plurality of said another signal segment 510, 520, 530 and 540, and correspondingly, a plurality of the segment area 610, 620, 630 and 640 exist in the check range 420.

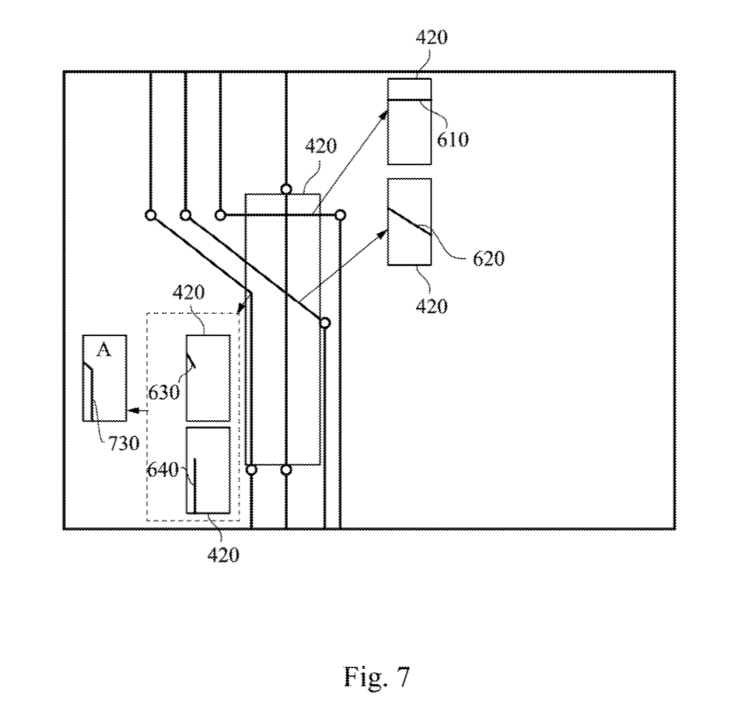

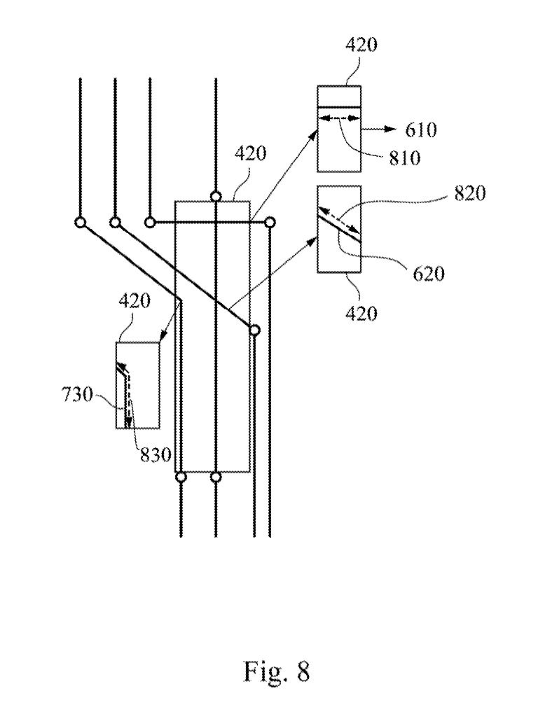

Then, as shown in FIG. 7, the processor 220 adds two or more of the segment areas 630 and 640 together corresponding to an identical signal, so as to generate at least one identical signal segment area 730.

Then, as shown in FIG. 8, the processor 220 divides the segment area 610 by a default width to determine a segment length 810 of one of said another signal segments of the adjacent layers in the check range 420. Similarly, the processor 220 divides the segment area 620 by the default width to determine a segment length 820 of another one of said another signal segments of the adjacent layers in the check range 420. Similarly, the processor 220 divides the identical signal segment area 730 by the default width to determine a segment length 830 of the others of said another signal segments of the adjacent layers in the check range 420.

The processor 220 determines whether the segment length 810, 820 and 830 in the check range 420 meets a predetermined length requirement, respectively. If any segment length does not meet the predetermined length requirement, the processor 220 stores data related to this segment length in the storage device 210.

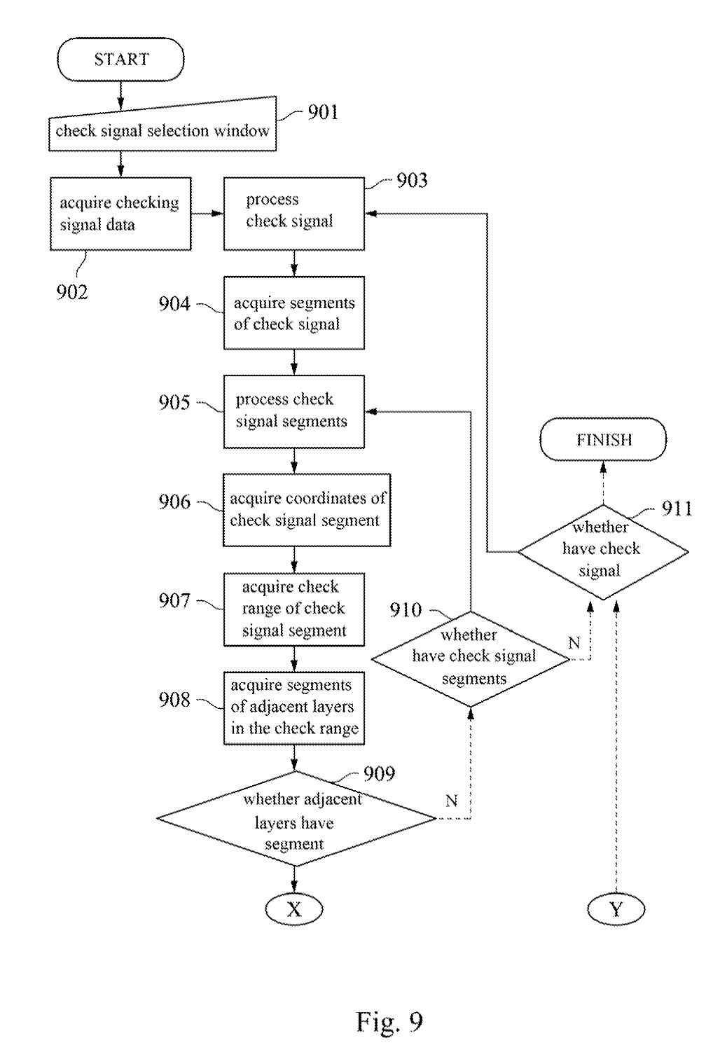

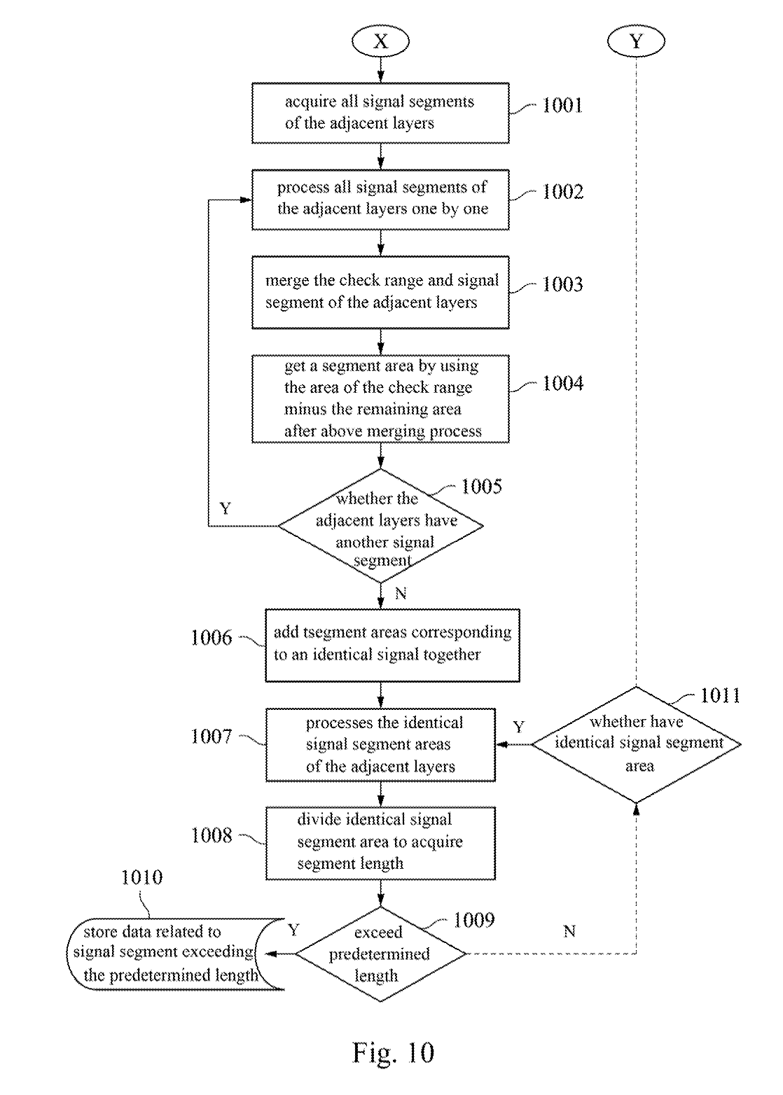

For a more complete understanding of the method performed by the system 200, refer to FIGS. 9 and 10. FIGS. 9 and 10 are a flow chart of a method of checking signals of adjacent layers of a circuit board according to one embodiment of the present disclosure. FIGS. 9 and 10 are connected through the nodes X and Y.

First, as shown in FIG. 9, in operation 901, the display 230 can display a check signal selection window. Thus, the user can use the input device 240 to select one or more check signals. In operation 902, the processor 220 acquires all of the checking signal data from the storage device 210. In operation 903, the processor 220 processes the one or more check signals one by one. In operation 904, the processor 220 acquires all segments of the check signal. In operation 905, the processor 220 processes these check signal segments one by one. In operation 906, the processor 220 the processor 220 acquire the coordinates of one check signal segment (e.g., the starting and ending coordinates of the check signal segments). In operation 907, the processor 220 acquires the check range of the check signal segment. In operation 908, the processor 220 acquires the signal segments of the adjacent layers in the check range. In operation 909, the processor 220 determines whether the adjacent layers have the signal segments. If the adjacent layers have no signal segment, in operation 910, the processor 220 determines whether one or more of check signal segments are not processed. If so, operation 905 is performed; if not, the processor 220 determines whether one or more of check signals are not processed. If so, operation 903 is performed; if not, the method is finished.

Moreover, if the adjacent layers have the signal segments as determined in operation 909, referring to FIG. 10, in operation 1001, the processor 220 acquires all signal segments of the adjacent layers from the storage device 210. In operation 1002, the processor 220 processes all signal segments of the adjacent layers one by one. In operation 1003, the processor 220 merges the check range and one signal segment of the adjacent layers. In operation 1004, the processor 220 gets a segment area by using the area of the check range minus the remaining area after above merging process. In operation 1005, the processor 220 determines whether the adjacent layers have another signal segment that is not processed. If so, operation 1002 is performed; if not, in operation 1006, the processor 220 adds two or more of the segment areas corresponding to an identical signal together, where the two or more segment areas belong to the adjacent layers. In operation 1007, the processor 220 processes the identical signal segment areas of the adjacent layers one by one. In operation 1008, the processor 220 divides one identical signal segment area by the default line width to acquire the segment length. In operation 1009, the processor 220 determines whether the segment length in the check range exceeds a predetermined length. If so, in operation 1010, the processor 220 stores data related to the signal segment of the adjacent layers that exceeds the predetermined length in the storage device 110; if not, in operation 1011, the processor 220 determine whether one or more of the identical signal segment areas of the adjacent layers are not processed. If so, operation 1007 is performed; if not, operation 911 in FIG. 9 is performed.

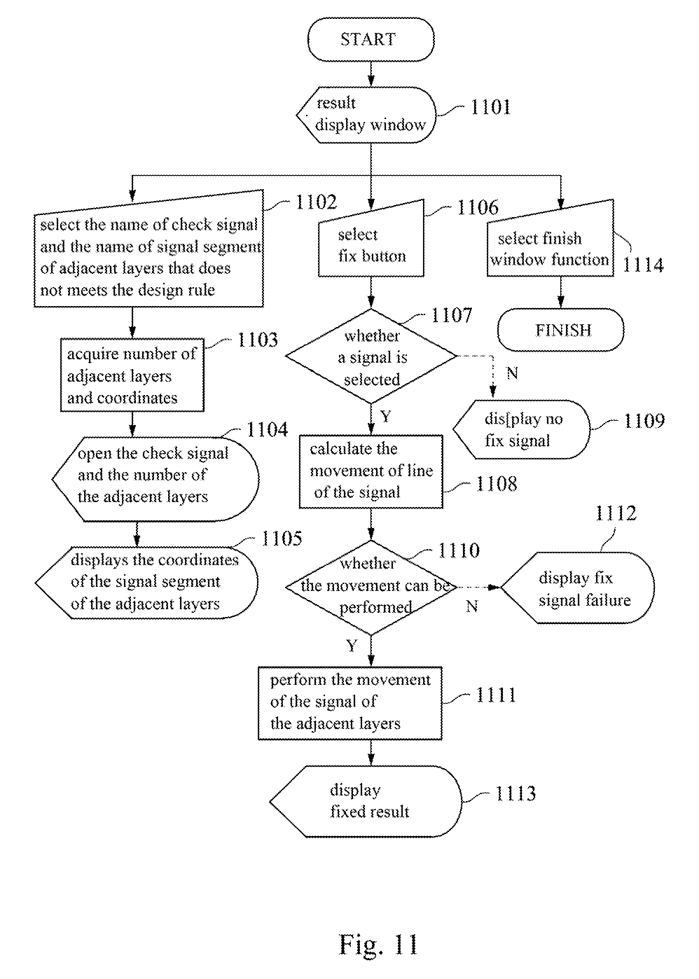

FIG. 11 is a flow chart of result display according to one embodiment of the present disclosure. As shown in FIG. 11, in operation 1101, the display 230 displays a result display window. In operation 1102, the user uses the input device 240 to select the name of the check signal and the name of the signal segment of the adjacent layers that does not meets the design rule. In operation 1103, the processor 220 acquires the number of the adjacent layers and coordinates. In operation 1104, the processor 220 opens the check signal and the number of the adjacent layers. In operation 1105, the display 230 displays the coordinates of the signal segment of the adjacent layers.

In operation 1106, the user selects a fix button through the input device 240. In operation 1107, the processor 220 determines whether a signal is selected. If not, in operation 1107, the display 230 displays no fix signal; if so, in operation 1108, the processor 220 calculates the movement of the line of the signal in space. Then, operation 1110, the processor 220 determines whether the movement can be performed. If not, in operation 1112, the display 230 displays fix signal failure; if so, in operation 1111, the processor 220 performs the movement of the signal of the adjacent layers. Then, in operation 1113, the display 230 displays the fixed result.

Moreover, in operation 1114, the user can selects the finish window function through the input device 240. Then, the processor 220 finishes the result display.

In view of the above, the present disclosure provides technology to achieve the purpose of automatic check. Thus, the check time can significantly shorten, and the omission check due to human error can be solved. The check results calculated by above system and/or above method are more accurate. For the precision design of the circuit board, electromagnetic interference between adjacent layers can be avoided. For the entire of the circuit board, reducing their design problems can also reduce the development costs.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A method of checking signals of adjacent layers of a circuit board, comprising steps of:
acquiring a check range of at least one check signal segment;
determining whether the adjacent layers have another signal segment in check range;
when the adjacent layers have said another signal segment, merging the check signal segment and said another signal segment to get a remaining area of the check range;
leaving a segment area in the check range by a total area of the check range minus the remaining area;
dividing the segment area in the check range by a default line width to determine a segment length; and
determining whether the segment length in the check range meets a predetermined length requirement.

2. The method of claim 1, wherein the step of acquiring the check range of the at least one check signal segment comprises:
based on a checking signal data, acquiring starting and ending coordinates of the check signal segment; and
establishing the check range of the check signal segment by using the starting and ending coordinates of the check signal segment with a predetermined distance.

3. The method of claim 1, further comprising:
when the adjacent layers have a plurality of said another signal segments, acquiring a plurality of the segment areas, adding two or more of the segment areas together corresponding to an identical signal, so as to generate at least one identical signal segment area.

4. The method of claim 3, further comprising:
dividing the identical signal segment area in the check range by the default line width to determine the segment length corresponding to the identical signal.

5. The method of claim 1, further comprising:
when the segment length does not meet the predetermined length requirement, storing data related to the segment length.

6. A system of checking signals of adjacent layers of a circuit board, comprising:
a storage device configured to store checking signal data; and
a processor electrically connected to the storage device and programmed to execute steps of:
based on the checking signal data, acquiring a check range of at least one check signal segment;
determining whether the adjacent layers have another signal segment in check range;
when the adjacent layers have said another signal segment, merging the check signal segment and said another signal segment to get a remaining area of the check range;
leaving a segment area in the check range by a total area of the check range minus the remaining area;
dividing the segment area in the check range by a default line width to determine a segment length; and
determining whether the segment length in the check range meets a predetermined length requirement.

7. The system of claim 6, wherein the step of the processor acquiring the check range of the at least one check signal segment comprises:
based on the checking signal data, acquiring starting and ending coordinates of the check signal segment; and
establishing the check range of the check signal segment by using the starting and ending coordinates of the check signal segment with a predetermined distance.

8. The system of claim 6, wherein the processor further executes a step of:
when the adjacent layers have a plurality of said another signal segments, acquiring a plurality of the segment areas, adding two or more of the segment areas together corresponding to an identical signal, so as to generate at least one identical signal segment area.

9. The system of claim 8, further comprising:
dividing the identical signal segment area in the check range by the default line width to determine the segment length corresponding to the identical signal.

10. The system of claim 6, wherein the processor further executes a step of:
when the segment length does not meet the predetermined length requirement, storing data related to the segment length.
